(19) United States
(12) Patent Application Publication
(10) Pub. No.: US 2014/0339142 A1
(43) Pub. Date: Nov. 20, 2014

(54) STANDALONE AQUARIUM FILTER

(71) Applicant: Kimberly Schaumburg, Vaughan, WA (US)

(72) Inventor: Kimberly Schaumburg, Vaughan, WA (US)

(21) Appl. No.: 13/897,885

(22) Filed: May 20, 2013

(51) Int. Cl. A01K 63/04

(52) U.S. Cl. CPC A01K 63/045
USPC 210/167.24; 210/484; 210/323.1; 210/167.23

(57) ABSTRACT

A standalone aquarium filter with a filter cage having a hinged or detachable top cover and a filter bag. The filter bag is adapted to be filled with a filtering medium. The filter cage has sides with openings sized to allow water to flow substantially transversely through the at least one filter cage and through the at least one filter bag. The filter cage is adapted to stand alone on the bottom of an aquarium tank while the filled filter bag remains substantially vertical within the at least one filter cage. A bottom portion of the filter cage further includes a ballast to stabilize the position of the at least one filter cage. The plastic material is selected to be strong enough to prevent most aquarium fish from accessing the filter media bag and scattering filter media throughout the tank.

### TECHNICAL FIELD

The present invention relates to a filter apparatus for aquariums and, more particularly, to an unpowered standalone aquarium filter for fresh water and salt water aquariums.

### BACKGROUND

Aquariums, especially salt water aquariums, represent a substantial investment for their owners in equipment, plant life, fish and accessories. Thus they require constant maintenance including the use of filtration systems in order to maintain a healthy aquatic environment. Presently available filtration systems are expensive and difficult to maintain. They usually require complicated pump systems, a sump, and multiple compartments some of which tend to become saturated with contaminants rendering them unsuitable for use, even to the point of causing them to add contaminants to the system.

Because typical filtration systems rely on electrically powered pumps to operate, they are subject to catastrophic failures when power is interrupted. This can lead to loss of an entire aquarium environment causing substantial financial loss, as well as loss of pets.

For example, in U.S. Pat. No. 8,262,907, having issue date Sep. 11, 2012 entitled “Composite sock filter for aquariums,” to Hudson et al. vertical sock filters for aquarium filter assemblies are disclosed. The sock filters typically include an annular collar coupled to filter material. The disclosed sock filters are not standalone devices but rather are configured for use in aquarium filter assemblies including attachment to a pump for pumping water from the aquarium tank directly into the sock filter such that the flow proceeds lengthwise through the sock filter from top to bottom.

As another example, in U.S. Pat. No. 5,306,421, having issue date Apr. 26, 1994 and entitled “Filtration system for a fish tank,” to Weinstein an internally-situated filter assembly for an aquarium tank is disclosed. The assembly includes a pump that returns filtered water collected in the catch basin to the aquarium compartment.

U.S. Pat. No. 4,622,148, having issue date Nov. 11, 1986 entitled “Aquarium filter system,” to Allan H. Willinger includes a filter assembly for use in filtering and treating contaminated water in an aquarium tank. A filter bag is used for receiving a continuous supply of contaminated water under a predetermined pressure supplied by a pump to which the filter bag is attached.

In U.S. Pat. No. 4,186,093, having issue date Jan. 29, 1980, to Allan H. Willinger and entitled “Bottom aquarium filter,” a bottom aquarium filter for an aquarium tank is disclosed. That filter includes a container having an inlet compartment which can receive contaminated water from the tank, and a filtration compartment which converts the contaminated water into decontaminated water. An air diffuser, attached by tubing to an air compressor located outside the aquarium tank, provides a stream of air bubbles to lift water from the decontaminated water compartment through an air lift tube. The water then leaves together with the air through an outlet in the air lift tube and back into the tank.

As shown in the examples above, known filter elements require complex assemblies of expensive containers, screens, pumps and filtering elements. Because of their complicated construction filtering media cannot be easily exchanged and maintained. Buildup of nitrates or phosphates is a common problem with hang on the back filters (HOB) or canister filters. Further, since they utilize pumps of various kinds they are subject to complete failure when power to the system is lost.

Use of unprotected filter media bags is undesirable for multiple reasons. Filter media bags left in a tank without a protective device could be subject to destruction by fish or invertebrates, including crabs or shrimp, which can tear up the media bags and scatter filter media throughout the tank. An unprotected loaded filter bag can be overgrown by algae or other undesirable materials that can also contaminate a tank.

The present invention addresses these drawbacks by providing, for the first time, a device that is independent of power sources and pumps, uses readily interchangeable filter media, may easily be removed or moved in a tank and may be placed in any convenient location on the bottom of a tank.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A standalone aquarium filter with a filter cage having a hinged or detachable top cover is disclosed. The filter cage is adapted to be filled with a filtering medium. The filter cage is constructed of a rigid mesh type, porous, plastic or plastic-like material, that has sides with openings sized to allow water to flow substantially transversely through the entire cage the at least one filter cage and through at least one filter bag if present. The filter cage is adapted to stand alone on the bottom of an aquarium tank while, in a preferred example embodiment, the filled filter bag, if present, remains substantially vertical within the at least one filter cage.

In one example a bottom portion of the filter cage further includes a ballast to stabilize the position of the at least one filter cage.

In one aspect, the filter cage is partitioned and comprises a top filter media cage and a bottom filter media cage, where each filter media cage includes a top cover and a filter bag suspended from each of the top covers.

In another aspect, the standalone aquarium filter includes at least one filter cage made from material selected from the group consisting of plastic netting, oyster bag material, plastic polymers, nylon polymers, acrylic polymers, and combinations thereof.

In another aspect, the standalone aquarium filter includes at least one filter cage made from plastic material so as to prevent fish or invertebrates, including crabs or shrimp, from tearing up the media bags and scattering filter media throughout the tank.

In another aspect, the standalone aquarium filter includes at least one filter cage that protects a loaded filter bag from being overgrown by algae or other undesirable materials.

In another aspect, the standalone aquarium filter includes filter media selected from the group consisting of chemical filter media, carbon-based media, metal removers, phosphate removers, resins and combinations thereof.

In yet another aspect, the standalone aquarium filter includes multiple filter bags, where each filter bag contains a different filter media.

In yet another aspect, the standalone aquarium filter includes filter media selected from the group consisting of biological filter media, manufactured porous rock-like material, porous rubble rock, and combinations thereof.

In yet another aspect, the standalone aquarium filter has ballast material selected from the group consisting of inert ballast, glass, porous rock and combinations thereof.

In yet another aspect, the standalone aquarium filter has a mesh fine enough to hold filter media without the need for a filter media bag.

In yet another aspect, the standalone aquarium filter has an extended base attached to the bottom portion.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a perspective view of an example of a standalone aquarium filter.

FIG. 2 shows a cut-away side view of the bottom portion of the standalone aquarium filter of FIG. 1 with filter bag and ballast components revealed.

FIG. 3 schematically shows a side view of an example of a standalone aquarium filter bottom compartment in an aquarium tank.

FIG. 4 schematically shows a perspective view of an alternate example of a standalone aquarium filter.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for a standalone aquarium filter. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to a standalone aquarium filter integrated into an aquarium tank. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

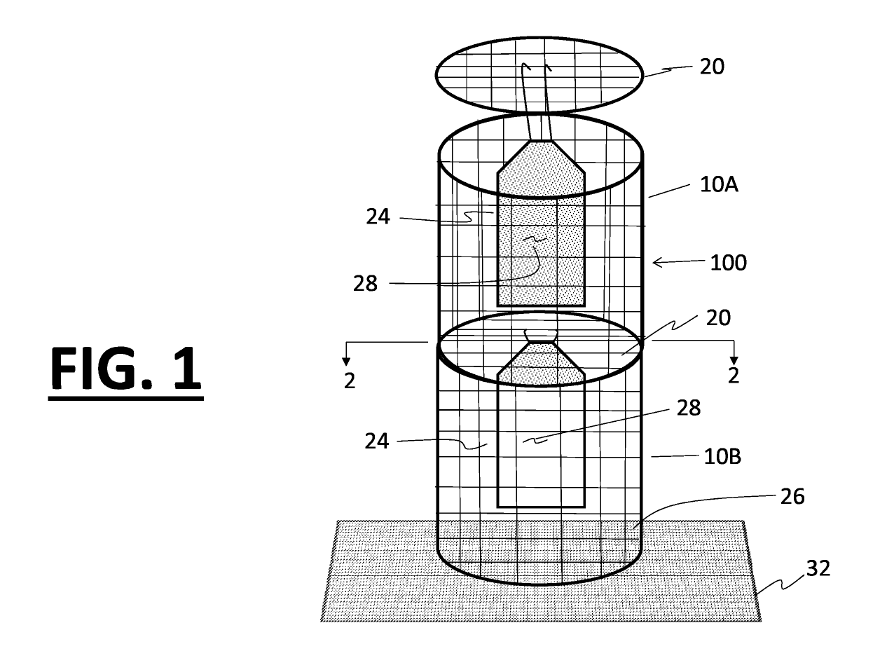

Referring now to FIG. 1, a perspective view of an example of a standalone aquarium filter is schematically shown. A standalone aquarium filter 100 includes a filter media cage partitioned into a top filter media cage 10A and a bottom filter media cage 10B. Each filter media cage includes a top element, such as, for example a cover, lid or cap 20. Depending on the size of media used and the cage mesh opening size, in a preferred example a filter bag 24 may be loaded into each of the filter media cages. In one example embodiment a filter bag may be vertically suspended from each of the top elements. The bottom filter media cage 10B is weighted at its base by ballast material 26. It will be understood that while a dual partitioned filter media cage is shown, this is only an example and the number of partitions for filter media cages in a standalone aquarium filter as contemplated herein may be one, two or more as may reasonably be accommodated in aquariums of various volumes.

Either the filter cages or, if used, each of the filter media bags are preferably filled with a filter media 28. In certain useful embodiments the filter media may include any commercially available filter media such as chemical filter media. Chemical filter media such as, for example, activated carbon-based media, metal removers, phosphate removers, resins and the like may be deposited directly into the filter cages or into the filter media bags if used. Each bag may contain a different filter media as desired for a particular application. In some applications the filter media may comprise biological filter media such as manufactured porous rock-like material, porous rubble rock, or the like.

The ballast material 26 may comprise any suitably inert ballast such as, for example, glass, porous rock or the like. The bottom filter media cage may be attached to an extended base 32 for additional stabilization of the standalone aquarium filter. The media cages may preferably be made from a rigid, plastic netting material, such as, for example, oyster bag plastic netting or the like.

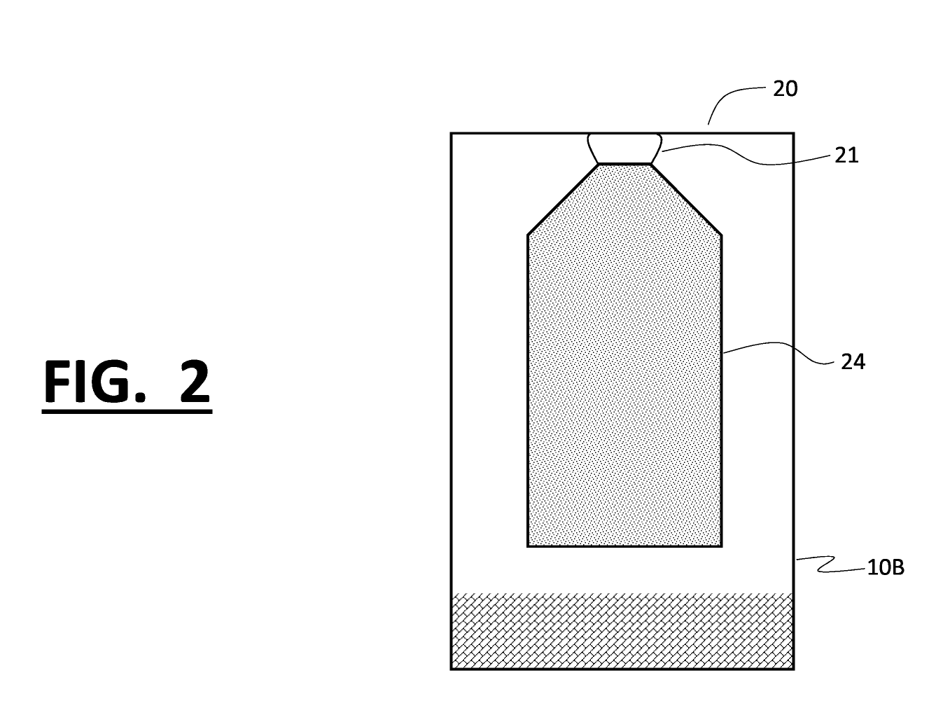

Referring now to FIG. 2, a cut-away side view of the bottom portion of the standalone aquarium filter of FIG. 1 with filter bag and ballast components revealed is shown in more detail. The bottom filter media cage 10B has a top lid 20 which is removably attached or hinged for ease of access to the media filter cage. The filter bag 24 is suspended from the top element 20 by any useful attachment elements 21 such as non-metallic hooks, clips, string, nylon line or the like so that the filter bag, when loaded with filter media, will hang substantially vertically or vertically suspended so as to maximize exposure to fluid flow. The filter bag 24 doesn't necessarily need to hang vertically, for example, it can be stuffed into the cage and the case can be positioned to allow water to flow thru it. In some cases it may be desirable to place the cage horizontally on the floor of an aquarium tank.

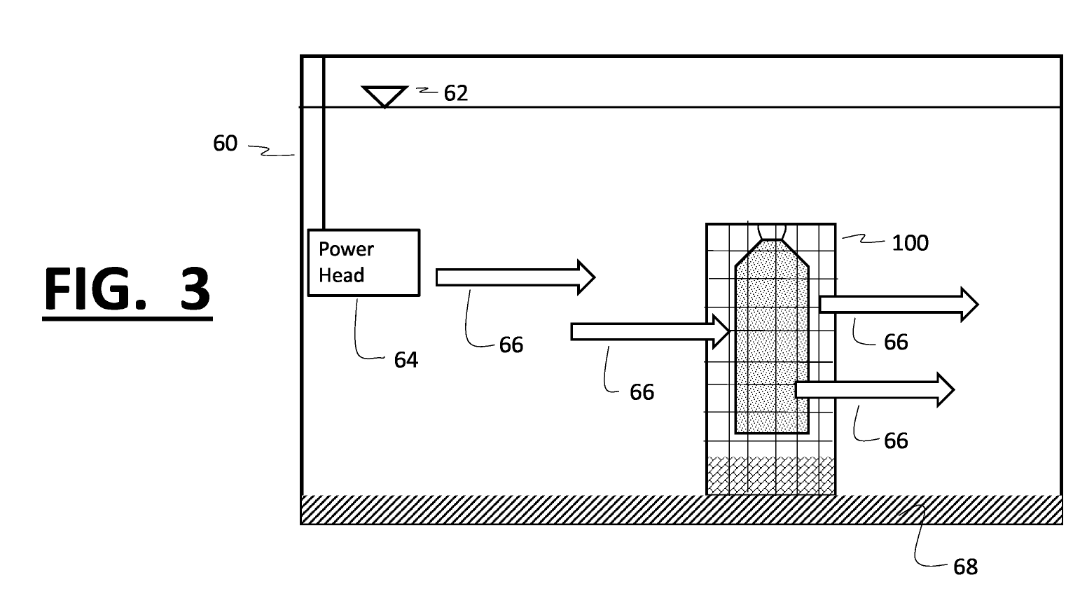

Referring now to FIG. 3, a side view of an example of a standalone aquarium filter bottom compartment in an aquarium tank is schematically shown. In one embodiment, the aquarium tank 60 includes fluid such as fresh water or salt water as indicated by fluid level marker 62. A power head 64 is mounted within the aquarium tank 60 to provide a fluid flow indicated by directional arrows 66. Note that the flow can be reversed by reversing the power head flow and the filter will still operate. A standalone aquarium filter 100 is placed on the tank bottom 68 positioned to align with the fluid flow so that water is continuously filtered as it flows through the standalone aquarium filter 100. When using power head pumps that simulate wave motions, water will still be filtered while flowing intermittently though the standalone filter. Should power be cut from the power head, the standalone aquarium filter 100 will continue to filter as water naturally moves through the tank due to movement caused by fish, by manually stroking or from any other available sources such as Brownian motion or the like.

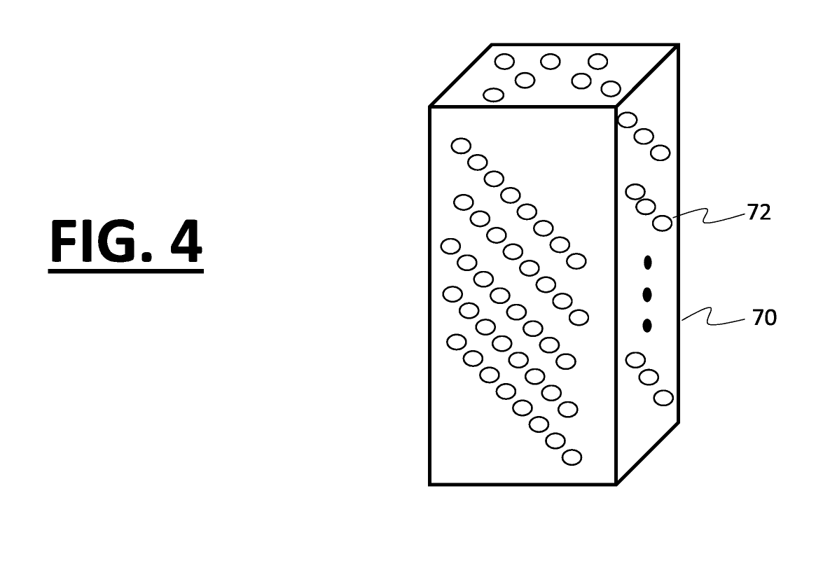

Referring now to FIG. 4, a perspective view of an alternate example of a standalone aquarium filter is schematically shown. An alternate embodiment of a standalone aquarium filter compartment 70 with flow openings 72 may be made from a material such as plastic polymers, nylon polymers, acrylic polymers, or the like. The openings shown are by way of example only and many more openings may be included as will be appreciated by those skilled in the art once they have the benefits of this disclosure. The filter bags and ballast may be mounted in the alternate compartments as described hereinabove. In a preferred embodiment, the at least one filter cage is made from plastic material so as to prevent fish or invertebrates, including crabs or shrimp, from tearing up the media bags and scattering filter media throughout the tank. In other example embodiments the media cage can be made with a tighter grouping of smaller openings or a tighter mesh that allows for water flow, but will contain media of a size larger than the openings or mesh, thus eliminating the need for a filter media bag.

Having described the elements and construction of the invention it is now believed to be useful to the understanding of the invention to describe an example of its use in practice. In the case of a filter media cage with a partition for hanging a second media bag as shown in FIG. 1, the filter bags are first filled with filter media of choice and then placed in a vertical orientation in part of the filter media cage.

The filter media cage that is placed on the bottom is also loaded with a sufficient amount of ballast to keep it from moving when placed in an aquarium tank. The amount of ballast will vary depending the size of the tank and the power head flow rate, as can easily be determined from placing the filter in the tank and turning on the power head. In alternative examples smaller cages can be loaded with several different media bags.

In some cases inert ballast material may not be needed as heavier filter media such as live rock, as used in a marine tank, or other large rock as used in a freshwater tank, may be used to stabilize the cages. Filter bags can easily be exchanged with fresh media by removing the entire standalone aquarium filter and replacing the bags by opening the media cage lids or while the standalone aquarium filter is still in the tank.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. A standalone aquarium filter for use in an aquarium tank having a bottom, the standalone aquarium filter comprising:
at least one filter cage having a hinged or detachable top cover;
at least one filter bag loaded into the at least one filter cage;
where the at least one filter bag is adapted to be filled with a filtering medium;
where the at least one filter cage is porous and has sides with openings sized to allow water to flow substantially transversely through the at least one filter cage and through the at least one filter bag; and
where the at least one filter cage is adapted to stand alone on the bottom of the aquarium tank.

2. The standalone aquarium filter of claim 1 wherein the at least one filter cage comprises a top filter media cage and a bottom filter media cage; and
where each filter media cage includes a top cover and a filter bag.

3. The standalone aquarium filter of claim 1 wherein the bottom of the at least one filter media cage is weighted at its base by the ballast material.

4. The standalone aquarium filter of claim 2 wherein the at least one filter cage is made from material selected from the group consisting of plastic netting, oyster bag material, plastic polymers, nylon polymers, acrylic polymers, and combinations thereof.

5. The standalone aquarium filter of claim 2 wherein the at least one filter cage is made from plastic material so as to prevent fish or invertebrates, including crabs or shrimp, from tearing up the media bags and scattering filter media throughout the tank.

6. The standalone aquarium filter of claim 1 wherein the at least one filter media bag is filled with a filter media.

7. The standalone aquarium filter of claim 6 where the filter media is selected from the group consisting of chemical filter media, carbon-based media, metal removers, phosphate removers, resins and combinations thereof.

8. The standalone aquarium filter of claim 2 wherein each filter bag contains a different filter media.

9. The standalone aquarium filter of claim 6 where the filter media is selected from the group consisting of biological filter media, manufactured porous rock-like material, porous rubble rock, and combinations thereof.

10. The standalone aquarium filter of claim 1 wherein the bottom of the at least one filter media cage contains a ballast material selected from the group consisting of inert ballast, glass, porous rock and combinations thereof.

11. The standalone aquarium filter of claim 1 further comprising an extended base attached to the bottom portion.

12. The standalone aquarium filter of claim 1 wherein the at least one filter cage is made from material selected from the group consisting of plastic netting, oyster bag material, plastic polymers, nylon polymers, acrylic polymers, and combinations thereof.

13. An aquarium filtering system comprising:
an aquarium tank;
a power head mounted within the aquarium tank to provide a directional fluid flow; and
a standalone aquarium filter placed on the tank bottom positioned apart from the power head and aligned with the directional fluid flow so that water is intermittently filtered as it flows through the standalone aquarium filter where the standalone filter includes at least one filter cage having a hinged or detachable top cover, at least one filter bag vertically suspended from the top cover, where the at least one filter bag is adapted to be filled with a filtering medium, where the at least one filter cage has sides with openings sized to allow water to flow substantially transversely through the at least one filter cage and through the at least one filter bag, where the at least one filter cage is adapted to stand alone on the bottom of the aquarium tank while the at least one filled filter bag remains substantially vertical within the at least one filter cage, and wherein a bottom portion of the at least one filter cage further includes a ballast to stabilize the position of the at least one filter cage.

14. The aquarium filtering system of claim 13 wherein the at least one filter cage comprises a top filter media cage and a bottom filter media cage; and
where each filter media cage includes a top cover and a filter bag suspended from each of the top covers.

15. The aquarium filtering system of claim 13 wherein the at least one filter media bag is filled with a filter media.

16. The aquarium filtering system of claim 15 where the filter media is selected from the group consisting of chemical filter media, activated carbon-based media, metal removers, phosphate removers, resins and combinations thereof.

17. The aquarium filtering system of claim 16 wherein each filter bag contains a different filter media.

18. The aquarium filtering system of claim 16 where the filter media is selected from the group consisting of biological filter media, manufactured porous rock-like material, porous rubble rock and combinations thereof.

19. The aquarium filtering system of claim 13 wherein the ballast material is selected from the group consisting of inert ballast, glass, porous rock and combinations thereof.

20. The aquarium filtering system of claim 13 further comprising an extended base attached to the bottom portion.

21. A standalone aquarium filter for use in an aquarium tank having a bottom, the standalone aquarium filter comprising:
at least one filter cage having a hinged or detachable top cover, wherein the at least one filter cage is made from plastic netting;
where the at least one filter cage is filled with filter media; and
where the at least one filter cage is adapted to stand alone on the bottom of the aquarium tank.
